(19) United States
(12) Patent Application Publication
(10) Pub. No.: US 2014/0195460 A1
(43) Pub. Date: Jul. 10, 2014

(54) METHOD FOR OBTAINING A HIGH RISE IN VALUE FOR INDIVIDUAL INVESTORS AND ENTERPRISES

(71) Applicant: Owe Westin, BODEN (SE)

(72) Inventor: Owe Westin, BODEN (SE)

(21) Appl. No.: 13/734,230

(22) Filed: Jan. 4, 2013

(51) Int. Cl. G06Q 40/06

(52) U.S. Cl. CPC G06Q 40/06
USPC 705/36 R

(57) ABSTRACT

Method for obtaining a high rise in value for individual investors and enterprises through at least two investing organizations, wherein said at least two investing organizations work together as co-operating investing organizations, said co-operating investing organizations in common develop strategies for the highest rise in value and influence over invested capital, said co-operating investing organizations arranging a common management function, and said common management function in all strategic matters co-operate with a project manager before making any investment of capital.

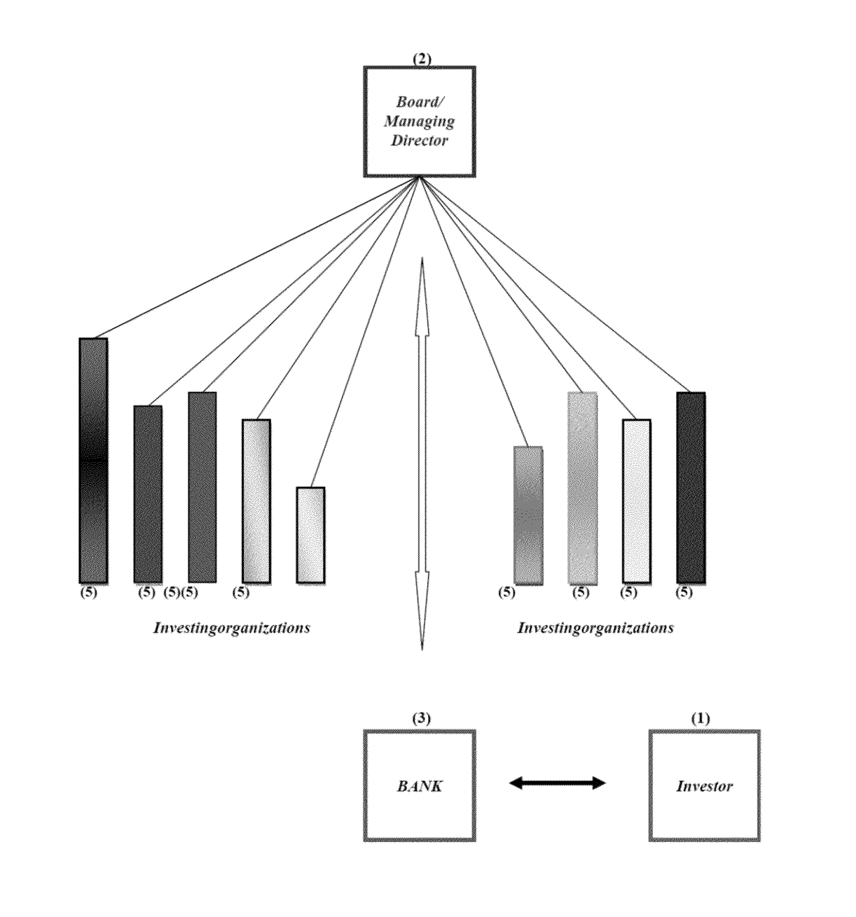

The present invention relates to a method for obtaining a high rise in value for individual investors and enterprises, as well as a method for facilitating the raising of risk capital for growing enterprises.

It is well known that especially small and mid-size enterprises have big difficulties with the supply of capital and being without long-range owners. The supply of capital to such enterprises normally takes place outside stock markets, leading to that small investors do not have any control over capital invested. In a global market this has severe implications, not at least in that big nations by centralized decisions decide in areas such as research and development. Not even big companies according to today's measurements can assert their positions, amongst others in that the owners withdraw too high profits and the financial sector take the rest of the profits. Smaller investors do not get any revenue leading to that the enterprises in need of investment capital have difficulties in attracting such capital.

The object of the present invention is to increase the availability of investment capital for enterprises in need of investment capital and at the same time increase the economic benefit for those providing the capital to be invested.

The above object is obtained in that according to the invention at least two investors or investing organizations co-operate wherein the two investors or investing organizations work together as co-operating investing organizations, said co-operating investing organizations in common develop strategies for the highest rise in value and influence over invested capital, said co-operating investing organizations arranging a common management function, and said common management function in all strategic matters co-operate with a project manager before making any investment of capital.

If the enterprises requiring investment capital in this way are owned wholly or partly by the co-operating investing organizations the enterprises can obtain global, stable and long-range owners having a good liquidity and being interested in the growth of the enterprises by being focused on research and development and a further expansion of the enterprises. The enterprises in addition will have better possibilities to keep up with competition when the owners of the capital also by way of their ownership control the enterprises.

The invention is further describer with reference to the enclosed schematic drawing, showing the formation of the method according to the invention.

Investors 1 who have money to invest in enterprises according to the invention supply their money to a bank 3 which is designed for investment through co-operating investing organizations 5, and the bank 3 is preferably also owned by said co-operating investing organizations 5. Investments in different enterprises through the co-operating investing organizations 5 are controlled by a management function 2 in connection with a project manager 4. It is necessary that the management function 2 and the project manager 4 agree on strategic matters for all investments made.

The bank 3 is the formal owner of all the assets invested through the co-operating investing organizations 5 in the enterprises, and each co-operating investing organization has in turn disposal claims on the bank 3 for the assets invested through the co-operating investing organization 5. Each individual investor 1 in this way has holdings in the investing organization 5 invested in, in proportion to his/her share of the investing organization's 5 share of the total assets of the commonly owned bank 3.

The co-operating investing organizations 5 preferably have different amounts of investment capital from the individual investor 1 as a requirement for investment through the investing organization 5. Consequently individual investors who want to invest different amounts do this through different investing organizations 5.

Both the bank 3 and the co-operating investing organizations 5 are controlled by the management function 2 in connection with the project manager 4. The management function 2 preferably comprises a board and a managing director.

The assets of the bank 3 are calculated as value of material assets, and being the basis on which investors 1 can withdraw capital from their share of the total assets of the commonly owned bank.

The investors 1 are in this way all joint-owners to the assets of the bank 3, and in a joint-owner congress the elect the people to run the co-operating investing organizations 5, especially the board and the managing director.

Each one of the co-operating investing organizations 5 is run independently of the other co-operating investing organizations 5, but all the co-operating investing organizations 5 preferably have the same management function 2.

The management function 2 in co-operation with said project manager 4 establishes rules and administrative instructions for the investing organization 5.

The project manager 4 is a function that is independent of the management function 2, i.e. of the board and the managing director. The project manager 4 is a key function and shall have special knowledge in technique, know-how, innovation and intellectual property rights.

As an alternative to a commonly owned bank 3 the money to be invested is supplied to an account in an existing bank to a special bank account to which the co-operating investing organizations 5 have full access. The bank 3 can be seen as an administrative unit which has control over all the assets of the investors 1 and the co-operating investing organizations 5.

1. Method for obtaining a high rise in value for individual investors and enterprises through at least two investing organizations, wherein
said at least two investing organizations working together as co-operating investing organizations and in common develop strategies for influence over invested capital, wherein the invested capital is administrated by a bank, said co-operating investing organizations having a common management function,
said common management function in all strategic matters co-operate and agree with a project manager before making any substantial investment of capital, and
wherein each investing organization has different amounts of investment capital from the individual investor as a requirement for investment through the investing organization, the individual investors thereby being joint-owners of the assets in each investing organization.

2. Method according to claim 1, wherein the capital of the co-operating investing organizations is invested in different lines of businesses or segments.

3. Method according to claim 1, wherein the co-operating investing organizations have a commonly owned bank for administration of invested capital.

4. Method according to claim 3, wherein the commonly owned bank is the formal owner of all assets.

5. Method according to claim 4, wherein the co-operating investing organizations have at their disposal claims on the bank.

6. Method according to claim 5, wherein each investor has holdings in the investing organization invested in, in proportion to his/her share of the investing organization's share of the assets of the commonly owned bank.

7. Method according to claim 1, wherein each investing organization is controlled by said management function.

8. Method according to claim 7, wherein said management function comprises a board and a managing director.

9. Method according to claim 8, wherein said board and said managing director in co-operation with said project manager establish rules and administration instructions for said investing organizations.

10. Method according to claim 8, wherein the co-operating investing organizations have a commonly owned bank for administration of invested capital, and said commonly owned bank is directly controlled by said board and said managing director.

11. Method according to claim 1, wherein said individual investors, at least initially, are natural persons.

12. Method according to claim 1, wherein said project manager has the overall responsibility for activities in said investing organizations.

13. Method for obtaining a high rise in value for individual investors and enterprises through at least two investing organizations, comprising steps of:
said at least two investing organizations working together as co-operating investing organizations, including sharing data defining invested capital amounts, and in common develop strategies for influence over invested capital, wherein the invested capital is administrated by a bank, said co-operating investing organizations having a common management function,
the at least two investing organizations initiating transactions resulting in investment of said capital, such that said common management function in all strategic matters co-operates and agrees with a project manager before making any substantial investment of said capital, and
calculating the assets of the bank as value of material assets, and based on such calculations, permitting the at least two investing organizations to withdraw capital from their share of the total assets of the commonly owned bank,
wherein each investing organization has different amounts of investment capital from the individual investor as a requirement for investment through the investing organization, the individual investors thereby being joint-owners of the assets in each investing organization.
